(19) United States
(12) Patent Application Publication
(10) Pub. No.: US 2025/0003786 A1
(43) Pub. Date: Jan. 2, 2025

(54) ASSEMBLY HAVING A DRIVE UNIT WITH CONNECTION LINES AND A SLEEVE FOR CONNECTING THE DRIVE UNIT TO A MEMBRANE OF A VIBRATION SENSOR, VIBRATION SENSOR, AND METHOD FOR CONNECTING A DRIVE UNIT TO A MEMBRANE OF A VIBRATION SENSOR

(71) Applicant: VEGA Grieshaber KG, Wolfach (DE)

(72) Inventors: Dominik Fehrenbach, Rottweil (DE); Jonas Schwab, Mühlenbach (DE)

(21) Appl. No.: 18/712,232

(22) PCT Filed: Oct. 17, 2022
(86) PCT No.: PCT/EP2022/078840

§ 371 Date: May 21, 2024

(30) Foreign Application Priority Data
Nov. 22, 2021 (DE) 10 2021 130 519.5

(51) Int. Cl. G01F 23/296

(52) U.S. Cl. CPC G01F 23/2968

(57) ABSTRACT

The invention relates to an assembly comprising a drive unit which has connection lines, and a sleeve for connecting the drive unit to a membrane of a vibration sensor, so that oscillations of the drive unit are transmitted to the membrane and oscillations of the membrane are transmitted to the drive unit where in the assembly has rotation locking means for rotationally locking the drive unit relative to the sleeve.

### CROSS-REFERENCE TO RELATED APPLICATIONS

This application is a US National Phase of PCT Application Serial Number PCT/EP2022/078840 filed Oct. 17, 2022, which published as PCT Publication WO2023/072662, which claims priority to DE 10 2021 130 519.5 filed Nov. 22, 2021, both of which are hereby incorporated by reference herein in their entirety.

### FIELD OF THE INVENTION

The invention relates to an assembly according to the preamble of claim 1, a vibration sensor according to the preamble of claim 9, and a method for connecting a drive unit to a membrane of a vibration sensor as claimed in claim 12.

### BACKGROUND OF THE INVENTION

Drive units can, for example, be used as transmitting and/or receiving devices in vibration sensors which are often employed in level measurement technology, for example as limit level sensors. Such drive units are also referred to as transmitting and/or receiving units.

The vibration sensor typically has a membrane that may be excited to oscillate via such a drive unit by which a mechanical oscillating unit arranged on the membrane, such as an oscillating fork, can, in turn, be excited to oscillate. Depending on the level up to which the mechanical oscillating unit is covered by a filling medium, and on the degree of viscosity of such filling medium, the mechanical oscillating unit oscillates at a characteristic frequency, which is detected by the vibration sensor and can then be converted into a measurement signal.

In the state of the art, two different types of drive unit are frequently used. In a first variant, a multi-segmented piezo element is bonded to the membrane. By applying an electrical voltage to one or more segments of the piezo element, the latter is excited into a bending or torsion and transmits this to the membrane, which is thereby set into vibration and causes the mechanical oscillating unit to vibrate in turn. This type of drive mechanism generates only a limited stroke and can only be employed with vibration sensors that are used at temperatures well below the glass transition temperature of the adhesive used and below the Curie temperature of the piezo material used. These sensors are not suitable for high-temperature applications above 150° C.

If a sensor with a larger stroke is required for an application or if an application is to be employed at higher temperatures, a second variant of drive unit, referred to as a piezo stack drive, is used. Here, a stack, which consists of a piezo unit having one or more piezo elements, and of one respective adjusting ceramic element arranged above and/or below the piezo unit, and of pressure pieces arranged above and/or below said adjusting ceramic elements, is clamped against the membrane of the sensor, for example by means of a clamping bolt arranged on the membrane. By applying an electrical voltage to the piezo elements, the latter change their expansion in the axial direction of the bolt and thus set the membrane in vibration.

A known vibration sensor having a drive unit in the form of a piezo stack drive is shown in FIG. 4. FIG. 4 shows a detail of a vibration sensor 100 known from prior art which is used, for example, as a limit level sensor in level measurement technology.

The vibration sensor 100 includes a membrane 90 that may be excited to oscillate via a piezo stack drive 11 which acts as a piezoelectric transmitting and/or receiving device and by means of which a mechanical oscillating unit 7 arranged on said membrane 90 can be excited to oscillate.

The vibration sensor 100 has a piezo stack drive 11 consisting of stacked piezo elements 15 contacted via electrodes 16, with an adjusting ceramic element 17 and a pressure piece 19, in this case made of a metallic material, being arranged above and below the stack. An insulation element 89 is additionally provided. The adjusting ceramic elements 17 are used to adjust a thermal expansion coefficient between the piezo elements 15 and the pressure pieces 19. The pressure pieces 19 are designed in such a way that a force effect from the piezo stack is tapped over the entire surface.

The piezo stack drive 11 is braced against the membrane 90 by means of a clamping bolt 91 integrally formed on the membrane 90 and by means of a clamping nut 92, so that vibrations of the piezo stack drive 11 are effectively transmitted to the membrane 90 and vice versa. Electrodes 16 for contacting the piezo elements 15 are contacted with electric connection lines 31 which run on the outside of the piezo stack drive 11 and are routed to an electronic sensor system on the rear. A rim 93 is arranged on the outside of the membrane 90 and extends in the rear direction. The rim 93 can be formed integrally with the membrane 90. A sensor housing 98 is arranged on the membrane 90 via the rim 93 and is connected to said rim or formed integrally therewith.

### SUMMARY OF THE INVENTION

The disadvantage of known sensors is that their installation is prone to errors and/or that the drive unit, and in particular the connection lines of the drive unit, can be subjected to great stress while being installed in the vibration sensor.

It is therefore the object of the present invention to provide a more advanced assembly comprising a drive unit and a sleeve, as well as a vibration sensor and a method.

The assembly of the invention comprises a drive unit and a sleeve. The sleeve serves for connecting the drive unit to a membrane of a vibration sensor in such a manner that the vibrations of the drive unit are transmitted to the membrane and vibrations of the membrane are transmitted to the drive unit. Preferably, the sleeve serves for bracing the drive unit against the membrane. The drive unit comprises connection lines, in particular electric connection lines. The assembly has rotary locking means for rotationally locking the drive unit with respect to the sleeve. The rotary locking means are preferably designed to ensure positive engagement. Preferably, the rotary locking means act directly between the drive unit and the sleeve. By means of the rotary locking means, the drive unit is preferably positively fixed to the sleeve in the circumferential direction of the sleeve.

In this way, the stress to which the drive unit is subjected during assembly in the vibration sensor can be reduced by reliably preventing torsion from being exerted on the drive unit relative to the sleeve during assembly, said torsion putting particular stress on the connection lines and on any contacts thereof.

The sleeve is preferably cylindrical. The sleeve preferably has a sleeve wall that may be shaped in the form of a jacket. The drive unit may preferably be arranged within the sleeve. Preferably, a mechanical oscillating unit is arranged at the front of the membrane. The mechanical oscillating unit comprises preferably an oscillating fork. The mechanical oscillating unit can be formed integrally with the membrane.

The drive unit preferably comprises at least one piezo element. The piezo element has preferably the shape of a solid disc, preferably a circular disc, and is thus not shaped in the form of a ring. In this way, a larger surface area of the piezo element is available for generating the drive power. The drive unit preferably comprises a piezo stack drive. The drive unit can, for example, have a stack including a piezo unit with at least one piezo element as well as an adjusting ceramic element placed above and/or below the piezo unit within the stack to equalize the thermal expansion coefficient. The at least one adjusting ceramic element may be adjoined by a pressure piece. Preferably, electrodes are provided for contacting the at least one piezo element. Preferably, the electrodes are brought into contact, particularly pressure-bonded, with the electric connection lines. For this purpose, the electric connection lines preferably comprise contacts, for example plug-in contacts. The contacts may be crimpable.

The rotary locking means preferably comprise at least one slot that is formed in the sleeve and preferably extends parallel to the sleeve axis and, further preferably, comprises at least one projection that is formed on the drive unit and may be arranged within this slot. Thus, the rotary locking means can be realised in a particularly reliable manner.

In the context of this publication, the term “slot” refers to any elongated depression, including, for example, the depression constituted by any groove formed in the sleeve.

The sleeve may have at least one groove formed in particular on the inner side of its sleeve wall and preferably extending parallel to the sleeve axis, and the slot may be realised by the depression constituted by this groove.

Preferably, the at least one slot is configured as a recess formed in the sleeve that completely penetrates the sleeve wall in the radial direction of the sleeve.

If the rotary locking means comprise two radially opposite slots formed in the sleeve and two projections formed in the drive unit that may each be arranged in one of these slots, then provision is made for a particularly robust and reliable rotary lock.

A rotary lock that is at least largely free of play can be created if the at least one projection is designed to correspond to its associated slot.

The rotary lock can be particularly robust if the at least one slot is dovetail-shaped and preferably the at least one projection is also dovetail-shaped. The slots and/or projections can be designed to be mirror-symmetrical to one another, preferably by reference to a plane comprising the sleeve axis.

Instead of one slot or two slots, a greater number of slots, such as three, four, five, six or more slots and a corresponding number of projections can also be provided.

The slots can have sizes and/or shapes differing from one another and the projections can be designed to correspond to these, so that the drive unit can only be arranged within the sleeve in exactly one rotational orientation relative thereto, i.e. the alignment of the drive unit within the sleeve is predetermined. This may facilitate mounting.

A further reduction of the load to which the drive unit is subjected upon installation in the vibration sensor can be achieved if the connection lines are routed within the at least one projection. This may prevent the connection lines from kinking, especially at their contacts. Preferably, the connection lines are routed within the at least one projection in a tension-relieving manner, and may, for example, be bonded.

Preferably, the sleeve has a clamping portion for positioning the drive unit relative to the cylindrical sleeve—and preferably within said sleeve—and/or for bracing the drive unit against the membrane. The clamping portion preferably has the form of a threaded hole having a female thread. Preferably, the at least one slot of the sleeve extends also into the clamping portion, preferably so over its entire axial extent. The female thread of the clamping portion is therefore preferably slotted, preferably completely, i.e. over the entire axial extent of the female thread, by the at least one slot.

Preferably, the drive unit has a central region which is preferably cylindrical and in which at least one piezo element of the drive unit can be arranged.

An accommodation portion of the sleeve is preferably arranged adjacent to the clamping portion. Preferably, the accommodation portion serves for accommodating the central region of the drive unit. The accommodation portion is preferably cylindrical. The diameter of the accommodation portion may be larger than the diameter of the threaded hole.

The assembly preferably comprises a clamping screw. The thread of the clamping screw is preferably a male thread corresponding to the female thread of the clamping portion. The clamping screw is preferably rotatable relative to the assembly. The clamping screw can be captively arranged on the assembly.

The clamping portion may preferably be used and the clamping screw may further preferably be used to fix a position of the drive unit within the sleeve in the direction of the sleeve axis, and further preferably the drive unit may thus be braced against the membrane if the sleeve is attached to said membrane. Particularly preferably, the drive unit may be positioned in various, preferably continuously variable positions relative to the sleeve by means of the clamping portion and the clamping screw. The clamping screw can be realised as a stud bolt.

The clamping screw is preferably solid and therefore preferably has no apertures, for example for conducting electric lines. The clamping screw can therefore have an internal actuating recess, such as a hexagon socket, to be used as a drive mechanism or actuating surface.

Preferably, the clamping portion makes it possible to set and adjust a pre-tensioning force of the drive unit. This term refers in particular to the force with which the components of the piezo stack drive need to be pressed together in order for this piezo stack drive to function properly. Preferably, the clamping portion and the clamping screw can be used to generate a previously known pre-tensioning force of the drive unit.

An axial bearing is particularly preferred formed between the clamping screw and the drive unit. The axial bearing is preferably an axial slide bearing. The axial bearing is preferably configured in such a manner that the drive unit provides a sliding surface and the clamping screw provides a corresponding end face. The sliding surfaces of the drive unit and of the end face can be flat. Centring means may be provided for centring the end face of the clamping screw relative to the sliding surface of the drive unit. The centring means can comprise a circumferential projection or several non-circumferential projections formed on the circumference of the sliding surface of the drive unit or on the circumference of the end face of the clamping screw.

Preferably, the sleeve has an insertion opening through which the drive unit can be inserted into the sleeve. Preferably, the sleeve has only exactly one insertion opening. This means that the drive unit preferably cannot be inserted into the sleeve from both sides, but only from one side.

Preferably, the sleeve has a contact opening which is preferably arranged opposite the insertion opening and by means of which the membrane can be mechanically contacted by the drive unit.

The sleeve preferably has an annular portion that is preferably closed, i.e. without any interruptions.

Preferably, the at least one slot is located adjacent to the annular portion. If there are several slots, all slots are preferably located adjacent to the annular portion. This can provide several advantages. On the one hand, the stability of the sleeve can be increased and it can thus be ensured, for example, that the sleeve does not fall apart, even when provided with several slots, in the course of its mounting within the vibration sensor. The annular portion can be arranged at an axial end region of the sleeve, preferably opposite the insertion opening. The annular portion can prevent the drive unit from being inserted through the annular portion, for example by its opening being too small for the drive unit to be passed therethrough with its at least one projection. This can make the annular portion particularly robust. While preferably preventing the drive unit from being inserted through the annular portion, said annular portion does allow the membrane to be mechanically contacted by the drive unit through its opening. Preferably, the opening of the annular portion is the contact opening of the sleeve.

The insertion opening is preferably arranged opposite the annular portion.

Preferably, the at least one slot on the side of the insertion opening of the sleeve extends, in an axial direction, through the entire sleeve wall. On the side of the insertion opening, the sleeve preferably has the shape of a ring interrupted by said at least one slot.

Preferably, the sleeve has a fastening portion for fastening the sleeve—preferably directly or indirectly—to the membrane or to a rim arranged on the membrane. Preferably, the fastening portion comprises the annular portion of the sleeve. Preferably, the fastening portion comprises a web projecting outwards from the sleeve in the radial direction of the sleeve. Preferably, the web extends completely or partially circumferentially.

As an alternative to the closed annular portion of the sleeve, the annular portion may be C-shaped, i.e. may have exactly one opening or interruption, which may be formed by the slot or by one of the slots. At least one slot may be formed in the axial direction of the sleeve, extending not only on one side of the sleeve, but completely through the sleeve wall. Similar to a snap ring, the sleeve can then preferably be elastically deformed, in particular compressed, to allow insertion into the vibration sensor and deform back, in particular relax, after reaching the mounting position in the vibration sensor, thus preferably forming an axial fixation within the vibration sensor. When deforming back, the web of the fastening portion of the sleeve may, for example, engage with a depression, such as an annular groove, of the vibration sensor. The depression can be formed on the rim that is arranged on the membrane. When screwed in, the clamping screw can prevent the sleeve from being compressed again and can thus prevent it from becoming detached.

The sleeve can be attached to the vibration sensor by means of a bayonet lock. This lock can be formed between the fastening portion of the sleeve and, for example, the rim arranged on the membrane. The bayonet lock can comprise a depression, for example an annular groove, formed in the vibration sensor, in particular in the rim arranged on the membrane.

The assembly may have an anti-rotation device which interacts with the membrane or with an element connected to the membrane in such a way that rotation of the assembly relative to the membrane is limited, and preferably prevented. The anti-rotation device may be configured as a cavity or projection formed in the web of the sleeve and as a corresponding projection or cavity formed in the vibration sensor. The anti-rotation device can be configured as an assembly aid. It can specify the rotational orientation in which the sleeve can be mounted relative to the membrane.

Preferably by means of the rotary locking means, the drive unit can be preferably arranged in the sleeve in such a way that it is positively fixed in the sleeve in the radial direction of the sleeve. This ensures the correct radial position of the drive unit within the sleeve and further reduces the susceptibility to errors during assembly. The possibility of arranging the drive unit with a positive fit in the sleeve in the radial direction of the sleeve can be achieved exclusively or partially by the interaction between the at least one projection and the at least one slot.

The positive fit in the radial direction of the sleeve can be achieved, for example, by the dovetail shapes of two opposing slots and corresponding projections. The drive unit can be arranged in the sleeve in a self-centring manner—preferably by means of the rotary locking means. Preferably, the rotary locking means employed in this embodiment may also be referred to as rotary locking and centring means.

The vibration sensor according to the invention comprises a membrane that can be set in vibration and, preferably, a connection part. In addition, the vibration sensor according to the invention comprises an assembly as described above, including a drive unit and a sleeve. The drive unit is braced against the membrane by means of the sleeve. The vibration sensor may be a limit level sensor.

Preferably, the sleeve is attached directly or indirectly to the membrane. Preferably, a rim is arranged on the membrane, preferably on the rear side of the membrane. In the context of this publication, the expression “on the rear side of the membrane” is to be understood as referring to the side of the membrane opposite the mechanical oscillating unit. The rim can run circumferentially around the outside of the membrane. It can extend perpendicular to a membrane plane and is preferably shaped in the form of a web. The rim can be formed integrally with the membrane. The sleeve, preferably its web, can be attached to this rim.

Once the sleeve is attached to the membrane, the insertion opening of the sleeve preferably faces away from the membrane, preferably in such a way that the drive unit can still be inserted into the sleeve, even if the sleeve is already attached to the membrane.

Preferably, the sleeve is fixed within the vibration sensor by means of its web, preferentially solely by means of its web. Preferably, the web of the sleeve is interlockingly and/or forcefittedly fixed within the vibration sensor in the axial and/or radial direction of the sleeve. The web can be materially fixed within the vibration sensor, for example by welding.

The connection part of the vibration sensor is preferably arranged on the rear side of the membrane and is further preferably attached to the membrane. The connection part can be tubular. The connection part can be part of a sensor housing and/or a sensor extension. The connection part can be connected to the rim arranged on the membrane. The connection part can be materially connected, for example welded, to the membrane and/or to the rim arranged on the membrane.

Preferably, the sleeve, in particular its web, is fixed between the connection part and the membrane or the rim arranged on said membrane. Preferably, the connection part and/or the membrane or the rim arranged on said membrane has a step and further preferably a-preferably annular-contact area is provided radially outside this step between the connection part and the membrane or the rim arranged on said membrane. The step can provide a depression, for example an annular groove, in which the web is preferably arranged when the connection part and the membrane are connected to each other or when the rim is arranged on the membrane. Preferably, an undercut of the connection part and/or the membrane or the rim arranged on the membrane is formed axially adjacent to the step on one side or on both sides thereof. The undercut is preferably engaged from behind by the web of the sleeve.

Preferably, the web of the sleeve can be arranged between the connection part and the membrane or the rim arranged on said membrane before the connection part is connected to the membrane and/or to the rim arranged on the membrane. This connection can be used to fix the sleeve within the vibration sensor, for example by clamping the web of the sleeve between the rim arranged on the membrane and the connection part.

In the case of a material connection, such as a welding, formed between the connection part and the membrane or the rim arranged on the membrane, this material connection can also include the web of the sleeve. For example, when the connection part and the rim arranged on the membrane are welded together, the web can thus also be connected by welding.

In particular in the embodiment with a C-shaped annular portion or bayonet lock, the membrane or the rim arranged on the membrane can itself have an undercut or a depression, in particular an annular groove, for fixing the sleeve in the vibration sensor without the use of a connection part.

The membrane can have a contact projection on its rear side for making mechanical contact with the drive unit. The contact projection can be arranged centrally by reference to the membrane and/or centrally between tines of the oscillating fork. The contact projection may, for example, be shaped in the form of a spherical cap or of a cylinder.

The pre-tensioning force of the drive unit and the force with which the drive unit is braced against the membrane is preferably produced by the same element or elements-preferably the clamping portion and the clamping screw. In this way, the assembly step of separately generating the pre-tensioning force before generating the force with which the drive unit is pressed against the membrane can be omitted.

In vibration sensors known from the state of the art, the drive unit often works in tension and transmits tensile forces to the membrane—for example via a clamping bolt integrally formed with the membrane. A drive unit that works in tension can also be within the scope of the invention. The preferred operating principle of the drive unit, however, is to work under pressure. Preferably, a compressive force can be introduced into the membrane by the drive unit, preferably centrally, so that the latter is deformed outwards in the axial direction when considered from the side of the sensor.

The method according to the invention for connecting a drive unit to a membrane of a vibration sensor includes the following steps:
translationally inserting the drive unit—preferably through the insertion opening—into a sleeve attached directly or indirectly to the membrane and—preferably simultaneously-causing a rotary lock, preferably with a positive fit, between the drive unit and the sleeve, preferably by using rotary locking means,
screwing a clamping screw into a clamping portion of the sleeve,
connecting the drive unit to the membrane by bracing the drive unit against the membrane by means of the clamping screw, preferably while simultaneously generating a predetermined pre-tensioning force in the drive unit. Preferably, bracing takes place by means of an axial bearing formed between the clamping screw and the drive unit.

The method according to the invention facilitates the assembly and reduces the stress to which the drive unit is subjected. Preferably, the drive unit is not rotated relative to the sleeve during the procedure.

The clamping screw is preferably screwed in after the rotary lock has been effected.

Preferably, these process steps are preceded by one or more of the following process steps:
providing a connection part,
heating the connection part and/or the membrane and/or the sleeve, for example for the purpose of coating or during a coating process,
cooling the connection part and/or the membrane and/or the sleeve or allowing them to cool down,
arranging, preferably clamping, the web of the sleeve between the connection part and the membrane or a rim arranged on said membrane,
connecting the connection part to the membrane or to the rim arranged on the membrane, for example by welding.

This type of subsequent assembly can protect the drive unit from severe stresses such as thermal loads occurring during coating processes. Heating and cooling, or allowing to cool, can also take place after the connection part has been connected to the membrane.

All features described in the context of this publication may be combinable with the claimed assembly, the claimed vibration sensor and the claimed method.

### BRIEF DESCRIPTION OF THE DRAWINGS

In the following, the present invention will be explained in greater detail, with reference being made to embodiment examples and to the attached figures. In the drawings:

FIG. 1 is a perspective view of an embodiment example of the assembly in an exploded view,

FIG. 2 is an assembled representation of the assembly of FIG. 1,

FIG. 3 is a longitudinal section through a membrane, the sleeve of the assembly of FIG. 1 and a connection part attached to the membrane, with the drive unit being omitted,

FIG. 4 is a longitudinal section through a vibration sensor according to the state of the art (already discussed).

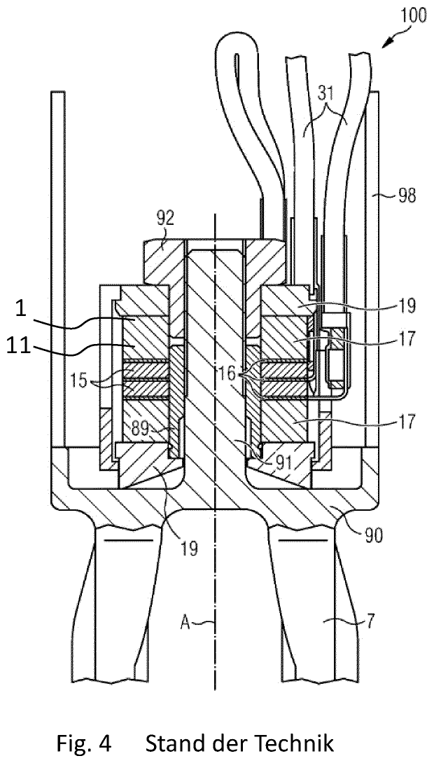

In the figures, unless otherwise indicated, identical reference signs denote identical components with the same function.

### DETAILED DESCRIPTION OF THE DRAWINGS

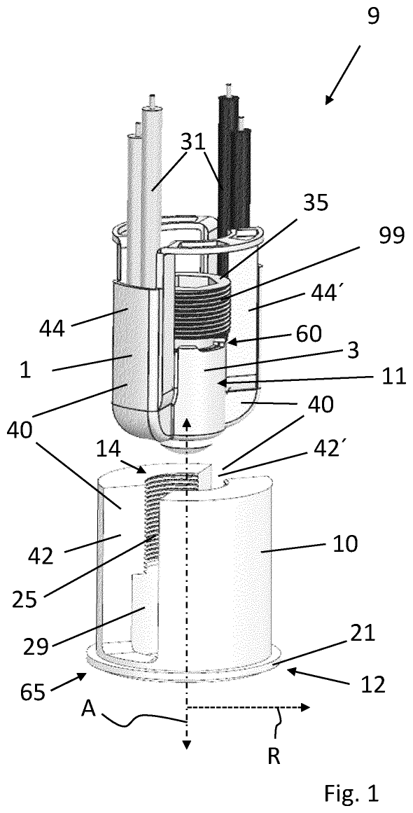

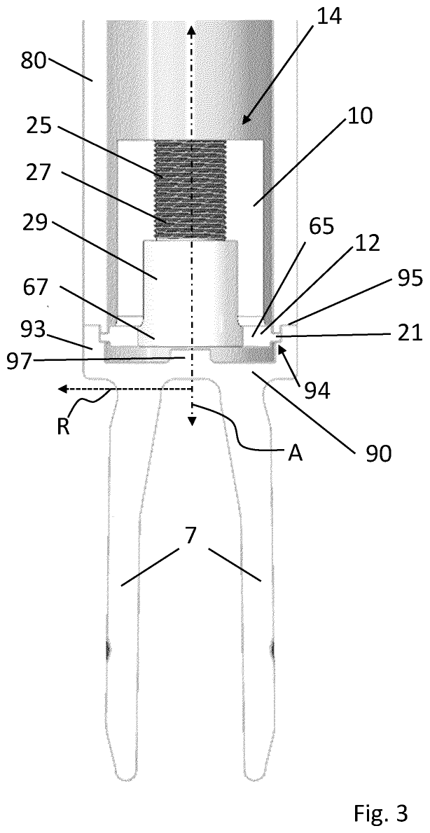

As shown in FIG. 1, for example, the illustrated embodiment example of an assembly 9 comprises a drive unit 1 and a cylindrical sleeve 10. The sleeve 10 is used to connect the drive unit 1 to a membrane 90 (see FIG. 3) of a vibration sensor, or more precisely to brace the drive unit 1, which has electric connection lines 31, against the membrane 90. To reduce the stress to which the drive unit 1 is subjected during installation in the vibration sensor, the assembly 9 has positively fitting, rotary locking means 40 for rotationally locking the drive unit 1 relative to the cylindrical sleeve 10.

The drive unit 1 preferably comprises a piezo stack drive 11. More precisely speaking, it has a stack including a piezo unit with at least one piezo element in the form of a solid disc as well as an adjusting ceramic element placed above and/or below the piezo unit within the stack to equalize the thermal expansion coefficient (not specifically represented in FIGS. 1 to 3).

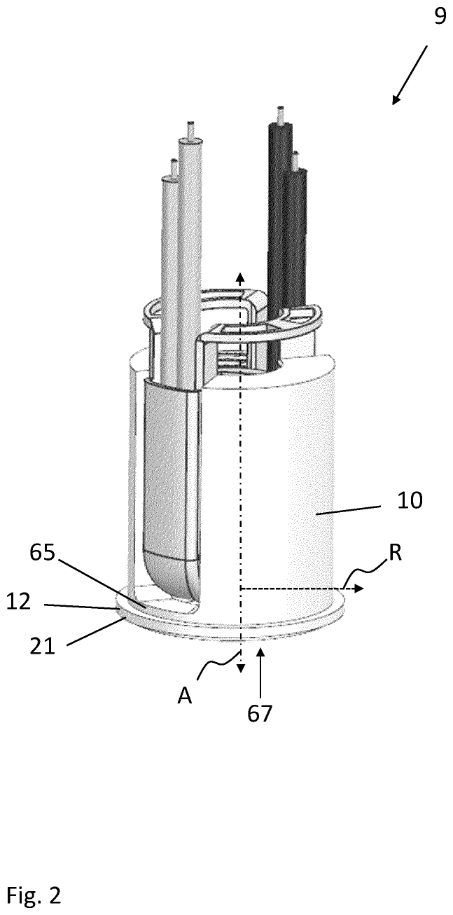

As best shown in FIGS. 1 and 2, the rotary locking means 40 comprise two radially opposite slots 42, 42′ which are formed in the sleeve 10 and extend parallel to the sleeve axis, and two projections 44, 44′ which are formed in the drive unit 1 and configured to correspond to these slots 42, 42′ so that they may be arranged in these slots 42, 42′. The slots 42, 42′ and the projections 44, 44′ are dovetail-shaped. The slots 42, 42′ and the projections 44, 44′ are each mirror-symmetrical to one another by reference to a plane comprising the sleeve axis.

As shown in FIGS. 1 and 2, for example, the connection lines 31 are routed in the two projections 44, 44′.

As can best be seen in FIG. 3, the sleeve 10 has a clamping portion 25. The latter is designed as a female thread 27 double-slotted by the slots 42, 42′ of the sleeve, with the slots 42, 42′ each extending over the entire axial extent of the clamping portion 25.

The assembly 9 also comprises a clamping screw 35 with a male thread 99 corresponding to the female thread 27 of the clamping portion 25 (see FIG. 1).

By means of the clamping portion 25 and the clamping screw 35, a position of the drive unit 1 within the sleeve 10 can be fixed in the axial direction A of the sleeve and in this way, with the sleeve 10 attached to the membrane 90, the drive unit 1 can be braced against the membrane 90 and at the same time a predetermined pre-tensioning force of the drive unit 1 can be generated in the drive unit 1.

Between the clamping screw 35 and the drive unit 1, an axial bearing 60 is provided which is designed as an axial slide bearing in that the drive unit 1 provides a flat sliding surface and the clamping screw 35 provides a corresponding flat end face.

The clamping portion 25 of the sleeve 10 is adjoined by a cylindrical accommodation portion 29 of the sleeve 10 which serves for accommodating a central region 3 of the drive unit 1. The accommodation portion 29 is cylindrical. The diameter of the accommodation portion 29 is larger than the diameter of the threaded hole, see e.g. FIG. 3. In the embodiment example shown, the positive fit of the drive unit 1 within the sleeve 10 in the radial direction of the sleeve, which causes the drive unit 1 to self-centre in the sleeve 10, is therefore effected exclusively by the interaction between the projections 44, 44′ and the slots 42, 42′.

The double-headed arrow A in FIGS. 1 to 3 shows not only the axial direction A of the sleeve but also the position of the sleeve axis.

As can be seen, for example, from FIG. 1, the two slots 42, 42′ adjoin a closed annular portion 65 of the sleeve 10, which is arranged in an axial end region of the sleeve 10. The closed annular portion 65 prevents the drive unit 1 from being inserted through the closed annular portion 65, as its opening 67, which forms the contact opening of the sleeve 10, is too small for the drive unit 1 with its projections 44, 44′ to pass through.

The sleeve 10 has exactly one insertion opening 14 opposite the closed annular portion 65.

The sleeve 10 has a fastening portion 12 for fastening the sleeve 10 directly to a rim 93 arranged integrally on the membrane 90. The rim 93 is arranged circumferentially around the membrane 90. The rim 93 extends perpendicular to a membrane plane and is shaped in the form of a web. The fastening portion 12 comprises the closed annular portion 65 of the sleeve 10 and has a web 21 which projects outwards from the sleeve 10 in its radial direction and encircles the latter completely.

Once the sleeve 10 is attached to the membrane 90, as shown in FIG. 3, the insertion opening 14 points away from the membrane 90, so that the drive unit 1 can still be inserted into the sleeve 10, for example after the membrane, the connection part and/or the sleeve have undergone a thermally stressful coating process.

Arranged on its rear side, the membrane 90 has a central contact projection 97 in the form of a cylindrical shape for making mechanical contact with the drive unit 1. The contact projection can also be in the shape of a spherical cap.

As can be seen, for example, in connection with FIGS. 1 and 2, the drive unit 1 may be arranged in the sleeve 10 in such a way that it is positively fixed in the sleeve 10 in the radial direction R of the sleeve 10.

In the vibration sensor shown partially in FIGS. 1 to 3, the drive unit 1 is braced against the membrane 90 (not shown). The sleeve 10 is fixed within the vibration sensor solely by means of its web 21. The web 21 of the sleeve is interlockingly and forcefittedly fixed within the vibration sensor both in the axial direction A and the radial direction R of the sleeve.

The vibration sensor comprises a tubular connection part 80 arranged at the rear of the membrane 90 and the web 21 of the sleeve is fixed between the connection part 80 and the rim 93. The connection part 80 and the rim 93 each have a step 94 for accommodating or clamping the web 21, and radially outside of this step 94 an annular contact area 95 is provided between the connection part 80 and the rim 93 in which the connection part 80 and the rim 93 can be welded to one another and/or can be connected to the web 21 by welding.

The pre-tensioning force of the drive unit 1 is caused by the same elements as the force with which the drive unit 1 is braced against the membrane 90, that is, by the clamping portion 25 and the clamping screw 35.

As can be seen from FIG. 3, a mechanical oscillating unit 7 shaped in the form of an oscillating fork and integrally formed with the membrane is arranged on the front of the membrane 90.

### REFERENCE SIGNS

1 drive unit
3 central region of the drive unit
7 mechanical oscillating unit
9 assembly
10 sleeve
11 piezo stack drive
12 fastening portion
14 insertion opening
15 piezo element
16 electrodes
17 adjusting ceramic element
19 pressure piece
21 web
25 clamping portion
27 female thread
29 accommodation portion
31 connection lines
35 clamping screw
40 rotary locking means
42, 42′ slots
44, 44′ projections
60 axial bearing
65 annular portion
67 opening
80 connection part
89 insulation element
90 membrane
91 clamping bolt
92 clamping nut
93 rim
94 step
95 contact area
97 contact projection
98 sensor housing
99 male thread
100 vibration sensor
A axial direction
R radial direction

1. An assembly including a drive unit having connection lines and a sleeve for connecting the drive unit to a membrane of a vibration sensor in such a way that vibrations of the drive unit are transmitted to the membrane and vibrations of the membrane are transmitted to the drive unit, wherein the assembly has rotary locking means for rotationally locking the drive unit with respect to the sleeve.

2. The assembly according to claim 1, wherein the rotary locking means comprise at least one slot of the sleeve and at least one projection of the drive unit-which can be arranged in this slot.

3. The assembly according to claim 1, wherein the rotary locking means comprise two radially opposite slots of the sleeve and two projections of the drive unit, each of which can be arranged in a respective one of the slots.

4. The assembly according to claim 2, wherein the connection lines are routed within the at least one projection.

5. The assembly according to claim 2, wherein the sleeve has a clamping portion for bracing the drive unit against the membrane and the clamping portion comprises a female thread slotted by the at least one slot.

6. The assembly according to claim 5, wherein the assembly comprises a clamping screw with a male thread corresponding to the female thread, and in that an axial bearing is formed between the clamping screw and the drive unit.

7. The assembly according to claim 2, wherein the at least one slot is adjacent to a closed annular portion of the sleeve and the sleeve has a fastening portion for fastening the sleeve to the membrane and the fastening portion comprises the closed annular portion of the sleeve and the fastening portion comprises a web extending in the radial direction.

8. The assembly according to claim 1, wherein the drive unit may be arranged in the sleeve in such a way that it is positively fixed within the sleeve in the radial direction of the sleeve.

9. A vibration sensor comprising a membrane that can be set in vibration and an assembly of claim 1 connected thereto.

10. The vibration sensor according to claim 9, wherein the vibration sensor comprises a connection part and the sleeve is fixed between the connection part and the membrane.

11. The vibration sensor according to claim 9, wherein the drive unit comprises a piezo stack drive and the pre-tensioning force of the drive unit and the force with which the drive unit is braced against the membrane are effected by common elements.

12. A method for connecting a drive unit to a membrane of a vibration sensor including the following steps:
a. translationally inserting the drive unit into a sleeve attached directly or indirectly to the membrane and causing a rotary lock between the drive unit and the sleeve,
b. screwing a clamping screw into a clamping portion of the sleeve,
c. connecting the drive unit to the membrane by bracing the drive unit against the membrane by means of the clamping screw.
